(19) United States
(12) Patent Application Publication
(10) Pub. No.: US 2023/0127219 A1
(43) Pub. Date: Apr. 27, 2023

(54) SYSTEM AND METHOD OF AUTOMATIC MEDIA GENERATION ON A DIGITAL PLATFORM

(71) Applicant: FLIPKART INTERNET PRIVATE LIMITED, Bengaluru (IN)

(72) Inventors: Surbhi Mathur, Bangalore (IN); Samir Shah, Bangalore (IN); Aditya Vinay Vithaldas, Bengaluru (IN)

(73) Assignee: FLIPKART INTERNET PRIVATE LIMITED, Bengaluru (IN)

(21) Appl. No.: 17/969,391

(22) Filed: Oct. 19, 2022

(30) Foreign Application Priority Data
Oct. 20, 2021 (IN) 202141047626

(51) Int. Cl. G06F 16/335; H04N 21/81

(52) U.S. Cl. CPC G06F 16/335; H04N 21/81

(57) ABSTRACT

A system and method of automatic media generation on a digital platform. The method encompasses extracting from a plurality of product contents, a first set of attributes and a second set of attributes. The method thereafter comprises creating, at least one pair of media content(s) and corresponding correlated text content(s) based at least on a successful matching of the first set of attributes with the second set of attributes. Further the method comprises generating, frame(s) based on the at least one created pair of the media content(s) and the corresponding correlated text content(s). The method thereafter encompasses ranking, the one or more frames based on one or more attributes extracted from at least one of a user profile and a product search query. The method further comprises automatically generating, at least one target media on the digital platform based on the one or more ranked frames.

### RELATED APPLICATION

This application claims priority under 35 U.S.C. § 119 to Indian Patent Application No. 202141047626 filed on Oct. 20, 2021, the entire contents of which are incorporated herein by reference.

### TECHNICAL FIELD

The present invention generally relates to provision of contents on a digital platform and more particularly to systems and methods of automatic media generation on a digital platform.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With an advancement in digital and communication technologies, it is now possible to provide at any instance of time a number of facilities to users of electronic devices. For instance, the users of the electronic devices can communicate with each other, access a media in real time, buy or sell products online using various digital platforms such as social media platforms, media streaming platforms and e-commerce platforms, respectively. In order to enhance an experience of the users with the digital platforms, a number of solutions have been developed over a period to time. For instance, some of the currently known solutions provide the users various recommendations based on an analysis of the users’ browsing patterns, purchase history and the like details. However, these known solutions are limited to recommending a product and/or service offered by a digital platform and fail to automatically generate a media content on a digital platform at least to provide the users personalized details of a product and/or service via the generated media content. Also, some other known solutions encompasses summarizing in video(s), a content with product images and product descriptions of product(s) available on an e-commerce platform. These currently known solutions also have a number of limitations, for instance there is a little or no correlation between an image and a text displayed in each frame of the videos generated using these solutions. More specifically, the text displayed on a frame of said video may or may not accurately describe the image that is shown with the text, within that frame. These videos are also not personalized for the users of the e-commerce platforms. Also, no audio, personalized or otherwise, is part of said automatically generated videos. Furthermore, these videos are created with only static content limited to product images and the product description, usually provided by a seller who explicitly uploads the product information.

Also, some other known techniques provide a solution for generation of playable media from a structured data. More specifically, such solution encompasses use of: a structured data reading unit for reading content of a first structure, a transformation unit for transforming said content into a second structure and incorporating media play instructions, and a rendering unit for rendering content from the second structure using said media play instructions to generate playable media from the content. These currently known solutions also talk about generation of media from static content like text, images, but does not talk about maintaining any correlation between the text and the corresponding image. Also, in the currently known solutions there is no personalization of any generated media. Furthermore, some other known techniques provide a solution for automatically converting text-based information and content to video form. More specifically, said solution creates a video which preserves a main idea of a given input text, and is adapted to convey the essence of the text. According to the said solution a data is extracted from an input text and from other sources of information relevant to it, so that the text can be analyzed as a whole and with respect to its main content. After extracting all the possible data, the text is semantically analyzed, summarized and converted to a video as a configuration file. Such currently known solution is also limited to creating the videos using static content with particular emphasis on text. Also, said currently known solution fails to artificially synthesize media content based on context based attributes. Furthermore, said solution does not talk about personalization of the videos and a content retrieved for a ‘text’ is same for all users and not tailored based on any feature.

Therefore, there are a number of limitations of the current solutions and there is a need in the art to provide a method and system of automatic media generation on a digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system of automatic media generation on a digital platform. Another object of the present invention is to provide a solution for personalized product content summarization through automatic media (such as video) generation on an e-commerce platform. Also, an object of the present invention is auto-generation of media (such as videos) using static, dynamic and/or artificially generated content. Another object of the present invention is to provide a correct and up to date information via a media that is automatically generated at least based on a dynamic content. Further, an object of the present invention is to personalize the automatically generated media according to a search query, user profile and/or Q&As, on a product page of an e-commerce platform. Another object of the present invention is to dynamically rank frame(s) of the automatically generated media to put more focus on image frame(s) with an information relevant at least to a search query and/or user profile based signals. Yet another object of the present invention is to correlate an image with a product information by extracting: attributes from said image, and attributes from text description(s) and/or reviews comprising the product information; and matching the extracted attributes to create image-description pairs. Yet another object of the present invention is to artificially generate image(s) based on context based attributes extracted from a text data comprising a product information, in order to further generate frame(s) for automatic media generation.

Furthermore, in order to achieve the aforementioned objectives, the present invention provides a method and system of automatic media generation on a digital platform.

A first aspect of the present invention relates to the method of automatic media generation on a digital platform. The method encompasses extracting, by an extraction unit, a plurality of attributes from a plurality of product contents, wherein the plurality of attributes comprises a first set of attributes and a second set of attributes. The method thereafter comprises creating, by a processing unit, at least one pair of at least one media content and at least one corresponding correlated text content based at least on a successful matching of the first set of attributes with the second set of attributes. Further the method comprises generating, by the processing unit, one or more frames based on the at least one pair of the at least one media content and the at least one corresponding correlated text content. The method thereafter encompasses ranking, by the processing unit, the one or more frames based on one or more attributes extracted from at least one of a user profile and a product search query. The method further comprises automatically generating, by the processing unit, at least one target media on the digital platform based on the one or more ranked frames.

Another aspect of the present invention relates to a system of automatic media generation on a digital platform. The system comprises an extraction unit, configured to extract, a plurality of attributes from a plurality of product contents, wherein the plurality of attributes comprises a first set of attributes and a second set of attributes. The system further comprises a processing unit, configured to create, at least one pair of at least one media content and at least one corresponding correlated text content based at least on a successful matching of the first set of attributes with the second set of attributes. The processing unit is further configured to generate, one or more frames based on the at least one pair of the at least one media content and the at least one corresponding correlated text content. Thereafter, the processing unit is configured to rank, the one or more frames based on one or more attributes extracted from at least one of a user profile and a product search query. Further, the processing unit is configured to automatically generate, at least one target media on the digital platform based on the one or more ranked frames.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for automatic media generation on a digital platform, in accordance with exemplary embodiments of the present invention.

FIG. 2 illustrates an exemplary diagram depicting a generation of a pair of a media content and its corresponding correlated text content, in accordance with exemplary embodiments of the present invention.

FIG. 3 illustrates an exemplary method flow diagram [300] of automatic media generation on a digital platform, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, an extraction unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution for automatic media generation on a digital platform. In a preferred implementation the media that is to be automatically generated is a video, but the same is not limited thereto and said media may be an image such as in GIF and the like formats. Also, the digital platform may be an e-commerce platform in one of the preferred implementation. More specifically, the present disclosure provides a solution for automatically generating a target media (say a target video) on the digital platform (say an e-commerce platform) based on summarizing both static and dynamic content spanning varied product information modalities like product description, product images, reviews, pricing information, Q&A etc. Also, the present disclosure provides a solution for personalizing the automatically generated target media based on information such as a user search query, a user profile based signals like age, gender, purchase history, browsing patterns and the like data. More specifically, this personalization is achieved by creating a frame sequence in the automatically generated media by re-ranking a product information/frames of the automatically generated media based on the information such as the user search query, the user profile based signals and the like data. Therefore, based on the implementation of the features of the present invention, for a same user search query, a sequence of media frames could still be different for two different users based on the user-based features. Furthermore, the present invention also provides a solution to artificially generate image(s) to create frame(s) required to generate the target media on the digital platform, wherein said image(s) are generated based on context based attributes extracted from an information of a product present on the e-commerce platform.

Therefore, the present invention provides a novel solution of automatic media generation on a digital platform. The present invention also provides a technical advancement over the currently known solutions by using dynamic content like reviews, price, Q&A etc. in addition to using static content like product images and text which is generally provided by a seller, for automatic media generation on a digital platform. More specifically, based on the use of dynamic as well as static content, a more detailed and updated view of products is provided to the user as compared to the currently known solutions. Also, the present invention provides a technical advancement over the currently known solutions by providing a solution to personalize an automatically generated media, wherein the automatically generated media is personalized by dynamically ranking its frames to put more focus on image frames with an information relevant to a user search query, a user profile based signals and/or like data. The present invention also provides a technical advancement over the currently known solutions by generating frames for automatic generation of a media such that each generated frame comprises at least one correlated image-text pair. Also, the present invention provides a technical advancement over the currently known solutions by providing a personalized audio for a text present in each frame of the automatically generated media. The present invention also provides a technical advancement over the currently known solutions by artificially generating image(s) to create frames required to generate a media on the digital platform.

Hereinafter, exemplary embodiments of the present disclosure will be described in detail with reference to the accompanying drawings so that those skilled in the art can easily carry out the present disclosure.

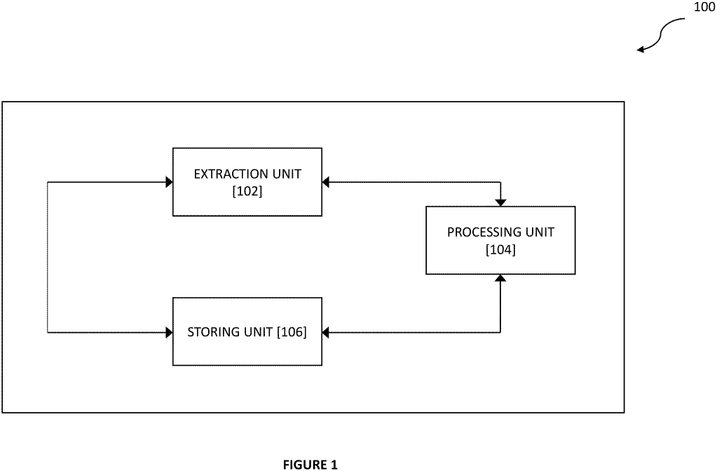

Referring to FIG. 1, an exemplary block diagram of a system [100] for automatic media generation on a digital platform is shown. The system [100] comprises at least one extraction unit [102], at least one processing unit [104] and at least one storage unit [106]. Also, all of the components/ units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to automatically generate a target media on a digital platform, with the help of the interconnection between the components/units of the system [100].

The extraction unit [102] of the system [100] is connected to the at least one processing unit [104] and the at least one storage unit [106]. The extraction unit [102] comprises one or more units that are at least capable of extracting one or more attributes from a content available on a digital platform. The content may be any static content and/or any dynamic content and the content may be available on the digital platform in a media and/or a textual format. Furthermore, as used herein ‘a product content’ is a content related to a product that is available on the digital platform. Also, each product content from a plurality of product contents is one of a static product content and a dynamic product content. The plurality of product contents also comprises at least one product content in a textual format and at least one product content in a media format. For example, say for a TV (i.e. a product) available on an e-commerce platform (i.e. a digital platform), a plurality of product contents may include but not limited to at least a content related to TV in a media format and at least a content related to TV in a textual format. Also in the given example each of the content related to TV in the media format and the content related to TV in the textual format is one of a static content related to the TV and a dynamic content related to the TV. For instance, the static content related to the TV may include images, videos and/or description etc. of said TV provided by a seller and the dynamic content related to the TV may include reviews, Q&A, pricing information and/or the like details related to the TV. More specifically, the static product content is a product content in which no further changes can be made and the dynamic product content is a product content which can be modified/altered at any instant of time based on one or more parameters such as a seller input, a user input to update a review/Q&A, a sale event (such as change in pricing due to discount offered) and the like.

In a preferred implementation the target media (i.e. the media that is to be automatically generated) is a video, but the same is not limited thereto and said media may be an image such as in GIF and the like formats. Also, in one of the preferred implementation the digital platform may be an e-commerce platform.

More specifically, in order to automatically generate the target media on the digital platform, the extraction unit [102] is configured to extract, a plurality of attributes from the plurality of product contents. The plurality of attributes comprises a first set of attributes and a second set of attributes. The first set of attributes is extracted from the at least one product content in the textual format and the second set of attributes is extracted from the at least one product content in the media format. In an implementation, the first set of attributes is extracted from a text present in at least one product content such as including but not limited to a text present in a product description, a product title, a product review, a Q&A section of a product etc. Also, in an example the first set of attributes comprises one or more attributes such as one or more named entities, one or more pre-defined attributes with respect to a particular category of a product (like energy rating for AC product description) and the like. In one other example for a vertical ‘mobile’ the first set of attributes may comprise one or more attributes related to an exchange, offer, price, EMI, upgrade info, camera and like data, wherein the exchange, offer, price, EMI, upgrade info, camera and like data are identified for the extraction of the first set of attributes, from a text present in a Q&A section associated with the vertical ‘mobile’.

Also, in an implementation, the second set of attributes is extracted from an image and/or a video provided as at least one product content, wherein the image and/or the video provided as the at least one product content may include but not limited to an image and/or a video provided by a seller for providing details of a product, an image and/or a video provided in a product review, an image and/or a video provided in a Q&A section of a product, etc. Also, in an example the second set of attributes comprises one or more visual attributes (such as one or more views of a product), one or more attributes extracted from a text present in the image and/or the video provided as the at least one product content (such as an energy rating for a AC provided in an image etc.) and the like attributes.

Once, the first set of attributes and the second set of attributes are extracted, the same are provided to the processing unit [104] by the extraction unit [102]. The processing unit [104] is configured to create, at least one pair of the at least one media content and at least one corresponding correlated text content based at least on a successful matching of the first set of attributes with the second set of attributes. More specifically, the processing unit [104] is firstly configured to match the one or more attributes extracted from the at least one product content in the textual format with the one or more attributes extracted from the at least one product content in the media format, wherein said matching may be one-to-one, many-to-one and many-to-many matching. Thereafter, the processing unit [104] is configured to create, the at least one pair of the at least one media content and the at least one corresponding correlated text content based at least on the successful matching of the one or more attributes extracted from the at least one product content in the textual format and the one or more attributes extracted from the at least one product content in the media format. For example, if a first attribute ‘full sleeves’ is extracted based on a text present in a description of a T-shirt present on an e-commerce platform and a second attribute ‘full sleeves’ is extracted based on an image of the T-shirt present on said e-commerce platform, the processing unit [104] is configured to create a pair of said image of the T-shirt with the text present in the description of the T-shirt based on a successful matching of the first attribute and the second attribute. Also, in an implementation based on the matching of the first set of attributes with the second set of attributes a matching score may be generated which further helps in identifying said matching as one of a successful and an unsuccessful matching of the first set of attributes with the second set of attributes. In an example, the matching score may be a binary such as 0 or 1, or true or false, wherein 0 or true indicate successful matching while 1 or false indicate unsuccessful matching.

Also, in an event of the unsuccessful matching of the first set of attributes with the second set of attributes, in order to create the at least one pair of the at least one media content and the at least one corresponding correlated text content, the processing unit [104] is firstly configured to detect, a set of context based attributes from the first set of attributes. Thereafter, in the given event, the processing unit [104] is configured to generate, the at least one media content based on the set of context based attributes. Further, once the at least one media content is generated the processing unit [104] is then configured to create, the at least one pair of the at least one media content and the at least one corresponding correlated text content. More specifically, for the one or more attributes extracted from the product content present in the text format, for which a corresponding image (i.e. media content) with one or more similar attributes is not available, the processing unit [104] is configured to generate an image artificially based on one or more context based attributes, wherein the one or more context based attributes are detected from the one or more attributes extracted from the product content present in text format.

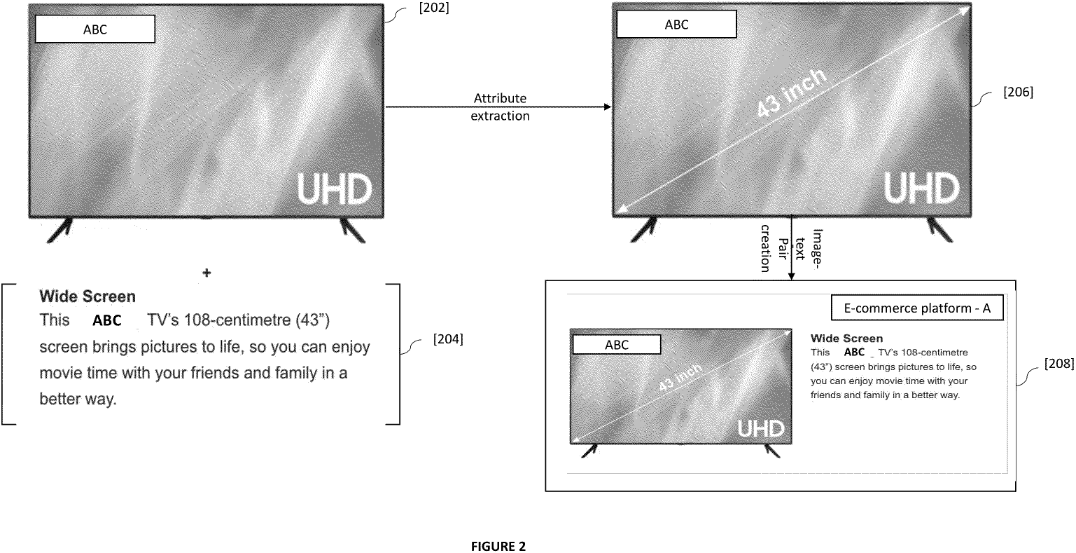

Furthermore, in FIG. 2 an exemplary diagram depicting a generation of a pair of a media content and its corresponding correlated text content is shown, in accordance with exemplary embodiments of the present invention. More particularly, FIG. 2, at [202] depicts a product content in a media format (i.e. an image of a TV) and at [204] depicts a product content in a text format (i.e., a description of said TV). [206] in FIG. 2 depicts an artificially generated image, wherein the image is artificially generated based on an unsuccessful matching of attribute(s) (say attribute dimension) extracted from the image of the TV and the description of the TV depicted at [202] and [204], respectively. More specifically, based on the unsuccessful matching of the attribute(s) extracted from the image of the TV and the description of the TV, the processing unit [104] is configured to extract one or more context based attributes (i.e., Dimension - 43 inch) from the description of the TV. Further the processing unit [104] is configured to artificially generate the image of the TV depicting the dimension 43 inch based on the extracted context based attribute i.e., dimension 43-inch. Once the image of the TV is generated artificially, the processing unit [104] is configured to create a pair of the generated image of the TV and the description of said TV. FIG. 2, at [208] depicts such exemplary pair of the generated image of the TV and the description of said TV.

Once, the at least one pair of the at least one media content and the at least one corresponding correlated text content is created, the processing unit [104] is thereafter configured to generate, one or more frames based on the at least one pair of the at least one media content and the at least one corresponding correlated text content. In an implementation, to generate the one or more frames, the processing unit [104] is configured to use semantic segmentation techniques to extract a foreground from a background for a product content in a media format (say for an image) and render it on a custom background with a text. Also, in another implementation, to generate the one or more frames, the processing unit [104] may also configured to intelligently decide a relative placement of an image and a corresponding text for each image-text pair. In yet another implementation, to generate the one or more frames, the processing unit [104] may also configured to use image augmentation techniques like translation based on context etc., to keep users engaged, instead of always displaying static images.

Further, once the one or more frames are generated, the processing unit [104] is further configured to rank, the one or more frames based on one or more attributes extracted from at least one of a user profile and a product search query. More particularly, the processing unit [104] is firstly configured to extract the one or more attributes from a text present in the product search query received at the digital platform, wherein such one or more attributes may include but not limited to one or more named entities, one or more pre-defined attributes with respect to a particular category of a product, like battery backup for smartphone product description. In an implementation, one or more product search queries may be bucketed into, but not limited to, one or more deep or broad queries. A deep query is a complex query that captures various attributes of a product and may ask for very specific feature(s) in the product. Also, a broad query is a generic query. For example, a broad search query may be ‘XYZ mobile’, while a deep search query may be ‘XYZ A21 mobile 256GB black’. In an implementation, a search query may be identified as one of the deep query and the broad query based on a pre-defined threshold of attributes. In an instance, the pre-defined threshold of attributes may be a pre-defined number of attributes which indicates that if in a search query a number of attributes are less than or equal to the pre-defined number of attributes said search query may be identified as the broad query, otherwise said search query may be identified as the deep query. Further, once the one or more attributes are extracted from the text present in the product search query, the processing unit [104] is also configured to extract one or more attributes based on one or more user profile based features such as gender, age, features based on browsing history, items purchased etc. Further, the one or more attributes extracted from the product search query coupled with the one or more features and/or the one or more attributes extracted from the user profile are used to rank the one or more frames and personalize the target media according to a session of a user. For example, based on the implementation of the features of the present invention for a broad search query (example ‘XYZ mobile’), more generic information can be shown in a target media, while for a deep search query (example ‘XYZ A21 mobile 256GB black’), more targeted information or a relevant information may be shown first in the target media. In other words, based on the implementation of the features of the present invention, an information may be shuffled (i.e. the one or more frames may be ranked) based at least on the product search query and/or the user profile, showing a relevant information first (i.e., before other information) or highlighting a relevant information.

Once the one or more frames are ranked, the processing unit [104] is thereafter configured to automatically generate, the at least one target media on the digital platform based on the one or more ranked frames. More specifically, in a preferred implementation, based on the ranking of the one or more frames, the processing unit [104] is configured to automatically generate at least one personalized video on an e-commerce platform, but the same is not limited thereto and in another implementation there may be any digital platform and/or a target media may be an image such as in GIF and the like formats.

Furthermore, in an implementation the processing unit [104] is also configured to automatically generate an audio script for a text content present in each frame from the one or more frames based on the one or more attributes extracted from at least one of the user profile and the product search query. For example, if a product search query in Hindi is received at an e-commence platform via a user account ‘A’, to search a product i.e., a ‘Table’. A list of search results will then be provided on the e-commence platform in response to the received product search query. Further for each of the search result one or more frames will be generated based on the implementation of the features of the present invention. Thereafter, for a text present in each frame from the one or more frames, an audio script is generated by the processing unit [104], wherein said audio script is generated based on one or more attributes extracted from the user profile ‘A’ and the product search query received in Hindi to search ‘Table’. In an instance, the audio script may be generated to read the text present in each frame in Hindi based on detection of the attribute(s) based on the product search query received in Hindi and/or a browsing pattern associated with the user profile ‘A’.

Further, in the given implementation, once the audio script is generated for the text content present in each frame from the one or more frames, the processing unit [104] is further configured to automatically generate the at least one target media on the digital platform based on the audio script for the text content present in said each frame. More specifically, in the given implementation the at least personalized video may be generated by combining the one or more frames with one or more corresponding personalized audio script. In an instance, for generation of a final frame that is required to generate a personalized video, a specific frame is combined with a specific audio script (i.e. a corresponding audio script that is generated for a text content present in said specific frame). Also, in the given instance, the audio script may have a time period associated with it which is required to read the text content present in said specific frame. Furthermore, in the given instance, once the frames required for generation of the personalized video (i.e. final frames) are generated, the personalized video is generated using these final frames (i.e., using frames combined with corresponding audio script). Therefore, based on the implementation of the features of the present invention, an option to automatically read aloud the text on each frame is provided, wherein one or more attributes extracted from the product search query coupled with the feature(s)/attribute(s) extracted from the user profile are used to adapt a language, tone etc., of the audio.

Furthermore, the processing unit [104] is also configured to assign, a time duration to each frame from the one or more frames based on a word length of the text content present in said each frame. Thereafter, the processing unit [104] is configured to display, the at least one target media on the digital platform for a time duration based on the assigned time duration of each frame. For example, if a target media is a video that is generated based on the implementation of the features of the present invention and said video comprises 4 frames. The first to fourth frames of said video are assigned with a time duration 20 seconds, 10 seconds, 15 seconds and 16 seconds, respectively. These time durations are assigned based on a word length of a text content present in corresponding frames, such as 20 seconds may be assigned based on a presence of 3 lines of text in the first frame, 10 seconds may be assigned based on a presence of 1 line of text in the second frame, 15 seconds may be assigned based on a presence of 2 lines of text in the third frame and 16 seconds may be assigned based on a presence of 2.1 lines of text in the fourth frame). The processing unit [104] in the given example is configured to display said video on a digital platform for a time duration i.e. 61 seconds that is based on the assigned time duration of each frame (i.e. a combination of 20, 10, 15 and 16 seconds). Therefore, based on the implementation of the present invention, a non-uniform time duration is provided to display a frame where one measure to decide said time duration is a word length of a text needed to describe that frame.

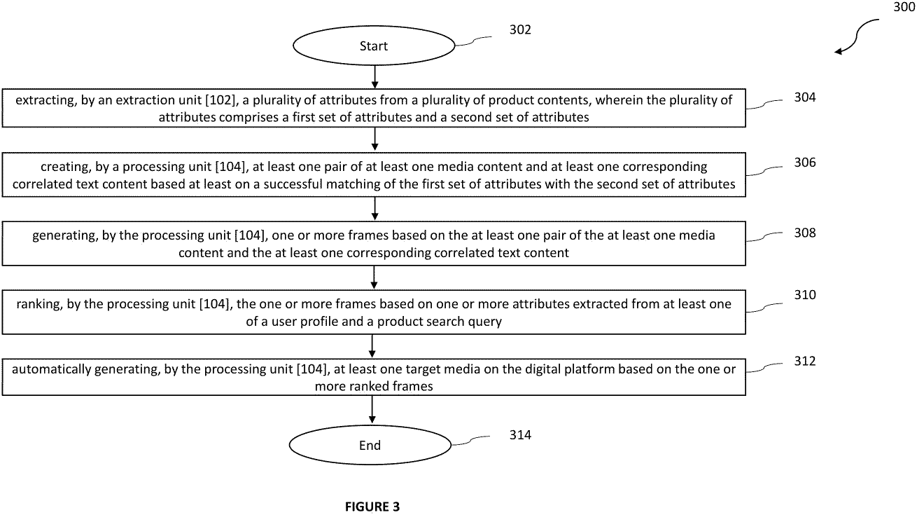

Referring to FIG. 3 an exemplary method flow diagram [300] for automatic media generation on a digital platform is shown in accordance with exemplary embodiments of the present disclosure. In an implementation the method is performed by the system [100]. Further, in an implementation, the system [100] is connected to a server unit to implement the features of the present disclosure. Also, as shown in FIG. 3, for automatic generation of a target media on a digital platform the method starts at step [302]. In a preferred implementation the target media (i.e. the media that is to be automatically generated) is a video, but the same is not limited thereto and said media may be an image such as in GIF and the like formats. Also, in one of the preferred implementation the digital platform may be an e-commerce platform.

Further, at step [304] the method comprises extracting, by an extraction unit [102], a plurality of attributes from a plurality of product contents. As used herein ‘a product content’ is a content related to a product that is available on the digital platform. Also, each product content from the plurality of product contents is one of a static product content and a dynamic product content. The plurality of product contents also comprises at least one product content in a textual format and at least one product content in a media format. For example, say for a Smartwatch (i.e. a product) available on an e-commerce platform (i.e. a digital platform), a plurality of product contents may include but not limited to at least a content related to Smartwatch in a media format and at least a content related to Smartwatch in a textual format. Also in the given example each of the content related to Smartwatch in the media format and the content related to Smartwatch in the textual format is one of a static content related to the Smartwatch and a dynamic content related to the Smartwatch. For instance, the static content related to the Smartwatch may include images, videos and/or description etc. of said Smartwatch provided by a seller and the dynamic content related to the Smartwatch may include reviews, Q&A, pricing information and/or the like details related to the Smartwatch. More specifically, the static product content is a product content in which no further changes can be made and the dynamic product content is a product content which can be modified/altered at any instant of time based on one or more parameters such as a seller input, a user input to update and/or to submit a review/Q&A, a sale event (such as change in offers) and the like.

Furthermore, the plurality of attributes comprises a first set of attributes and a second set of attributes. The first set of attributes is extracted from the at least one product content in the textual format and the second set of attributes is extracted from the at least one product content in the media format. In an implementation, the first set of attributes is extracted from a text present in at least one product content such as including but not limited to a text present in a product description, a product title, a product review, a Q&A section of a product etc. Also, in an example the first set of attributes comprises one or more attributes such as one or more named entities, one or more pre-defined attributes with respect to a particular category of a product (like a pattern for Shirts’ product description) and the like. In one other example for a vertical ‘T-shirt’ the first set of attributes may comprise one or more attributes related to a size, delivery, color, year, price, quality and the like data, wherein the size, delivery, color, year, price, quality and the like data are identified for the extraction of the first set of attributes, from a text present in a Q&A section associated with the vertical ‘T-shirt’. Also, in an implementation, the second set of attributes is extracted from an image and/or a video provided as at least one product content, wherein the image and/or the video provided as the at least one product content may include but not limited to an image and/or a video provided by a seller for providing details of a product, an image and/or a video provided in a product review, an image and/or a video provided in a Q&A section of a product etc. Also, in an example the second set of attributes comprises one or more visual attributes (such as one or more views of a product), one or more attributes extracted from a text present in the image and/or the video provided as the at least one product content (such as an energy rating for a AC provided in an image etc.) and the like attributes.

Once, the first set of attributes and the second set of attributes are extracted, the same are provided to a processing unit [104] by the extraction unit [102]. Next at step [306] the method comprises creating, by the processing unit [104], at least one pair of the at least one media content and at least one corresponding correlated text content based at least on a successful matching of the first set of attributes with the second set of attributes. More specifically, the method firstly encompasses matching by the processing unit [104], the one or more attributes extracted from the at least one product content in the textual format with the one or more attributes extracted from the at least one product content in the media format, wherein said matching may be one-to-one, many-to-one and many-to-many matching. Thereafter, the method encompasses creating by the processing unit [104], the at least one pair of the at least one media content and the at least one corresponding correlated text content based at least on the successful matching of the one or more attributes extracted from the at least one product content in the textual format and the one or more attributes extracted from the at least one product content in the media format. For example, if a first attribute ‘round neck’ is extracted based on a text present in a description of a T-shirt present on an e-commerce platform and a second attribute ‘round neck’ is extracted based on an image of the T-shirt present on said e-commerce platform, the method encompasses creating by the processing unit [104], a pair of said image of the T-shirt with the text present in the description of the T-shirt based on a successful matching of the first attribute and the second attribute. Also, in an implementation based on the matching of the first set of attributes with the second set of attributes a matching score may be generated which further helps in identifying said matching as one of a successful and an unsuccessful matching of the first set of attributes with the second set of attributes. In an example, the matching score may be a binary such as 0 or 1, or true or false, wherein 0 or true indicate successful matching while 1 or false indicate unsuccessful matching.

Also, in an event of the unsuccessful matching of the first set of attributes with the second set of attributes, the method of creating, by the processing unit [104], at least one pair of the at least one media content and the at least one corresponding correlated text content further comprises detecting, by the processing unit [104], a set of context based attributes from the first set of attributes. Thereafter, in the given event said method encompasses generating, by the processing unit [104], the at least one media content based on the set of context based attributes. Once the at least one media content is generated, the method in the given event leads to creating, by the processing unit [104], the at least one pair of the at least one media content and the at least one corresponding correlated text content. More specifically, for the one or more attributes extracted from the product content present in the text format, for which a corresponding image (i.e. media content) with one or more similar attributes is not available, the method encompasses generating by the processing unit [104], an image artificially based on one or more context based attributes, wherein the one or more context based attributes are detected from the one or more attributes extracted from the product content present in text format. For example, ‘waterproof’ attribute of a watch to be paired with an image of the watch with a splash of water. If such an image of said watch is not provided by the seller, the method encompasses artificially generating an image of said watch with the splash of water.

Once, the at least one pair of the at least one media content and the at least one corresponding correlated text content is created, at step [308] the method comprises generating, by the processing unit [104], one or more frames based on the at least one pair of the at least one media content and the at least one corresponding correlated text content. In an implementation, to generate the one or more frames, the method comprises using by the processing unit [104], one or more semantic segmentation techniques to extract a foreground from a background for a product content in a media format (say for an image) and render it on a custom background with a text. Also, in another implementation, to generate the one or more frames, the method comprises intelligently deciding by the processing unit [104], a relative placement of an image and a corresponding text for each image-text pair. In yet another implementation, to generate the one or more frames, the method comprises using by the processing unit [104], one or more image augmentation techniques like translation based on context etc., to keep users engaged, instead of always displaying static images.

Further, once the one or more frames are generated, the method at step [310] comprises ranking, by the processing unit [104], the one or more frames based on one or more attributes extracted from at least one of a user profile and a product search query. More particularly, the method encompasses firstly extracting by the processing unit [104], the one or more attributes from a text present in the product search query received at the digital platform, wherein such one or more attributes may include but not limited to one or more named entities, one or more pre-defined attributes with respect to a particular category of a product, like power ratings for AC product description. In an implementation, one or more product search queries may be bucketed into, but not limited to, one or more deep or broad queries. A deep query is a complex query that captures various attributes of a product and may ask for very specific feature(s) in the product. Also, a broad query is a generic query. For example, a broad search query may be ‘ABC TV’, while a deep search query may be ‘ABC smart TV with screen share capability’. In an implementation, a search query may be identified as one of the deep query and the broad query based on a pre-defined threshold of attributes. In an instance, the pre-defined threshold of attributes may be a pre-defined number of attributes which indicates that if in a search query a number of attributes are less than or equal to the pre-defined number of attributes said search query may be identified as the broad query, otherwise said search query may be identified as the deep query. Further, once the one or more attributes are extracted from the text present in the product search query, the method also comprise extracting by the processing unit [104], one or more attributes based on one or more user profile based features such as gender, age, features based on browsing history, items purchased etc. Further, the one or more attributes extracted from the product search query coupled with the one or more features and/or the one or more attributes extracted from the user profile are used to rank the one or more frames and personalize the target media according to a session of a user. For example, based on the implementation of the features of the present invention for a broad search query (example ‘ABC AC’), more generic information can be shown in a target media, while for a deep search query (example ‘ABC AC with 5 star rating’), more targeted information or a relevant information may be shown first in the target media. In other words, based on the implementation of the features of the present invention an information may be shuffled (i.e. the one or more frames may be ranked) based at least on the product search query and/or the user profile, showing a relevant information first or highlighting a relevant information.

Once the one or more frames are ranked, at step [312] the method comprises automatically generating, by the processing unit [104], at least one target media on the digital platform based on the one or more ranked frames. More specifically, in a preferred implementation, based on the ranking of the one or more frames, the method encompasses automatically generating by the processing unit [104], at least one personalized video on an e-commerce platform, but the same is not limited thereto and in another implementation there may be any digital platform and/or a target media may be an image such as in GIF and the like formats.

Furthermore, in an implementation the method also comprises automatically generating, by the processing unit [104], an audio script for a text content present in each frame from the one or more frames based on the one or more attributes extracted from at least one of the user profile and the product search query. For example, if a product search query in English is received at an e-commence platform via a user account ‘B’, to search a product i.e., a ‘Laptop’. A list of search results will then be provided on the e-commence platform in response to the received product search query. Further for each of the search result one or more frames will be generated based on the implementation of the features of the present invention. Thereafter, for a text present in each frame from the one or more frames, an audio script is generated by the processing unit [104], wherein said audio script is generated based on one or more attributes extracted from the user profile ‘B’ and the product search query received in English to search ‘Laptop’. In an instance, the audio script may be generated to read the text present in each frame in English based on detection of the attribute(s) based on the product search query received in English and/or a browsing pattern associated with the user profile ‘B’.

Further, in the given implementation the process of automatically generating, by the processing unit [104], at least one target media on the digital platform is further based on the audio script for the text content present in each frame from the one or more frames. More specifically, in the given implementation the at least personalized video may be generated by combining the one or more frames with one or more corresponding personalized audio script. In an instance, for generation of a final frame that is required to generate a personalized video, a specific frame is combined with a specific audio script (i.e. a corresponding audio script that is generated for a text content present in said specific frame). Also, in the given instance, the audio script may have a time period associated with it which is required to read the text content present in said specific frame. Furthermore, in the given instance, once the frames required for generation of the personalized video (i.e. final frames) are generated, the personalized video is generated using these final frames (i.e., using frames combined with corresponding audio script). Therefore, based on the implementation of the features of the present invention, an option to automatically read aloud the text on each frame is provided, wherein one or more attributes extracted from the product search query coupled with the feature(s)/attribute(s) extracted from the user profile are used to adapt a language, tone etc., of the audio.

Furthermore, the method also encompasses assigning, by the processing unit [104], a time duration to each frame from the one or more frames based on a word length of the text content present in said each frame. The method thereafter comprises displaying, by the processing unit [104], the at least one target media on the digital platform for a time duration based on the assigned time duration of each frame. For example, if a target media is a video that is generated based on the implementation of the features of the present invention and said video comprises 5 frames. The first to fifth frames of said video are assigned with a time duration 20 seconds, 10 seconds, 5 seconds, 11 seconds and 15 seconds, respectively. These time durations are assigned based on a word length of a text content present in corresponding frames, such as 20 seconds may be assigned based on a presence of 4 lines of text in the first frame, 10 seconds may be assigned based on a presence of 2 lines of text in the second frame, 5 seconds may be assigned based on a presence of 1 line of text in the third frame, 11 seconds may be assigned based on a presence of 2.1 lines of text in the fourth frame and 15 seconds may be assigned based on a presence of 3 lines of text in the fifth frame. The method in the given example encompasses displaying by the processing unit [104], said video on a digital platform for a time duration i.e. 61 seconds that is based on the assigned time duration of each frame (i.e. a combination of 20, 10, 5, 11 and 15 seconds). Therefore, based on the implementation of the present invention, a non-uniform time duration is provided to display a frame where one measure to decide said time duration is a word length of a text needed to describe that frame.

Further, after automatically generating and displaying the at least one target media on the digital platform, the method terminates at step [314].

Furthermore, there are a number of use cases of the present invention, and few use cases for an e-commerce platform are provided as below:
Catalog enrichment by product page information summarization - Based on the implementation of the features of the present invention a catalog on an e-commerce platform may be enriched with product videos, agnostic to seller(s). Given one or more product images, product description, title, reviews etc., a video summarizing various contents may be created.
Various features of various product may be highlighted by summarizing a content in a form of a video.
A product may be brought down to its core decision points, so as to get users to see (and hear) main details. Therefore, the present solution is helpful for the users who are reasonably familiar with reading, but not completely comfortable with large content consumption.
Voice based interaction with an e-commerce platform for buying/exploration experience may be provided by providing an audio of a product page summarization, adding to the hands-free experience.
How to use, unboxing videos/images may be automatically generated.

Thus, the present invention provides a novel solution of automatic media generation on a digital platform. The present invention also provides a technical advancement over the currently known solutions by using dynamic content like reviews, price, Q&A etc. in addition to using static content like product images and text which is generally provided by a seller, for automatic media generation on a digital platform. More specifically, based on the use of dynamic as well as static content, a more detailed and updated view of products is provided to the user as compared to the currently known solutions. Also, the present invention provides a technical advancement over the currently known solutions by providing a solution to personalize an automatically generated media, wherein the automatically generated media is personalized by dynamically ranking its frames to put more focus on image frames with an information relevant to a user search query, a user profile based signals and/or like data. The present invention also provides a technical advancement over the currently known solutions by generating frames for automatic generation of a media such that each generated frame comprises at least one correlated image-text pair. Also, the present invention provides a technical advancement over the currently known solutions by providing a personalized audio for a text present in each frame of the automatically generated media. The present invention also provides a technical advancement over the currently known solutions by artificially generating image(s) to create frames required to generate a media on the digital platform.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method of automatic media generation on a digital platform, the method comprising:
extracting, by an extraction unit [102], a plurality of attributes from a plurality of product contents, wherein the plurality of attributes comprises a first set of attributes and a second set of attributes;
creating, by a processing unit [104], at least one pair of at least one media content and at least one corresponding correlated text content based at least on a successful matching of the first set of attributes with the second set of attributes;
generating, by the processing unit [104], one or more frames based on the at least one pair of the at least one media content and the at least one corresponding correlated text content;
ranking, by the processing unit [104], the one or more frames based on one or more attributes extracted from at least one of a user profile and a product search query; and
automatically generating, by the processing unit [104], at least one target media on the digital platform based on the one or more ranked frames.

2. The method as claimed in claim 1, wherein each product content from the plurality of product contents is one of a static product content and a dynamic product content.

3. The method as claimed in claim 1, wherein the plurality of product contents comprises at least one product content in a textual format and at least one product content in a media format.

4. The method as claimed in claim 3, wherein the first set of attributes is extracted from the at least one product content in the textual format and the second set of attributes is extracted from the at least one product content in the media format.

5. The method as claimed in claim 1, creating, by the processing unit [104], at least one pair of at least one media content and at least one corresponding correlated text content further comprises:
detecting, by the processing unit [104], a set of context based attributes from the first set of attributes, in an event of unsuccessful matching of the first set of attributes with the second set of attributes,
generating, by the processing unit [104], the at least one media content based on the set of context based attributes, and
creating, by the processing unit [104], the at least one pair of the at least one media content and the at least one corresponding correlated text content.

6. The method as claimed in claim 1, the method further comprises automatically generating, by the processing unit [104], an audio script for a text content present in each frame from the one or more frames based on the one or more attributes extracted from at least one of the user profile and the product search query.

7. The method as claimed in claim 6, wherein automatically generating, by the processing unit [104], at least one target media on the digital platform is further based on the audio script for the text content present in each frame from the one or more frames.

8. The method as claimed in claim 7, the method further comprises:
assigning, by the processing unit [104], a time duration to each frame from the one or more frames based on a word length of the text content present in said each frame; and
displaying, by the processing unit [104], the at least one target media on the digital platform for a time duration based on the assigned time duration of each frame.

9. A system of automatic media generation on a digital platform, the system comprising:
an extraction unit [102], configured to extract, a plurality of attributes from a plurality of product contents, wherein the plurality of attributes comprises a first set of attributes and a second set of attributes; and
a processing unit [104], configured to:
create, at least one pair of at least one media content and at least one corresponding correlated text content based at least on a successful matching of the first set of attributes with the second set of attributes,
generate, one or more frames based on the at least one pair of the at least one media content and the at least one corresponding correlated text content,
rank, the one or more frames based on one or more attributes extracted from at least one of a user profile and a product search query, and
automatically generate, at least one target media on the digital platform based on the one or more ranked frames.

10. The system as claimed in claim 9, wherein each product content from the plurality of product contents is one of a static product content and a dynamic product content.

11. The system as claimed in claim 9, wherein the plurality of product contents comprises at least one product content in a textual format and at least one product content in a media format.

12. The system as claimed in claim 11, wherein the first set of attributes is extracted from the at least one product content in the textual format and the second set of attributes is extracted from the at least one product content in the media format.

13. The system as claimed in claim 9, wherein to create the at least one pair of the at least one media content and the at least one corresponding correlated text content, the processing unit [104] is further configured to:
detect, a set of context based attributes from the first set of attributes, in an event of unsuccessful matching of the first set of attributes with the second set of attributes,
generate, the at least one media content based on the set of context based attributes, and
create, the at least one pair of the at least one media content and the at least one corresponding correlated text content.

14. The system as claimed in claim 9, wherein the processing unit [104] is further configured to automatically generate an audio script for a text content present in each frame from the one or more frames based on the one or more attributes extracted from at least one of the user profile and the product search query.

15. The system as claimed in claim 14, wherein the processing unit [104] is further configured to automatically generate the at least one target media on the digital platform based on the audio script for the text content present in each frame from the one or more frames.

16. The system as claimed in claim 15, wherein the processing unit [104] is further configured to:
assign, a time duration to each frame from the one or more frames based on a word length of the text content present in said each frame, and
display, the at least one target media on the digital platform for a time duration based on the assigned time duration of each frame.
